(19) United States
(12) Patent Application Publication
(10) Pub. No.: US 2015/0166802 A1
(43) Pub. Date: Jun. 18, 2015

(54) COMPOSITION FOR FORMING A SEED LAYER

(71) Applicants: Atotech Deutschland GmbH, Berlin (DE); Intrinsiq Material Ltd., Hampshire (GB)

(72) Inventors: Richard Dixon, Hampshire (GB); Jose Pedrosa, Hampshire (GB); Dan Johnson, Hampshire (GB); Jorg Schulze, Oranienburg (DE); Matthias Dammasch, Berlin (DE); Dave Baron, Gloucestershire (GB); Frank Bruning, Berlin (DE); Robin Taylor, Troon (GB)

(73) Assignee: Intrinsiq Materials Ltd., Hampshire (GB)

(21) Appl. No.: 14/414,120

(22) PCT Filed: Jul. 12, 2013
(86) PCT No.: PCT/IB2013/055757

§ 371 Date: Jan. 12, 2015

(30) Foreign Application Priority Data
Jul. 12, 2012 (GB) 1212407.9

(51) Int. Cl. C09D 11/00; C25D 5/50; C25D 5/02; C25D 3/12; C25D 3/38; C25D 3/22; C25D 3/44; C25D 3/54; C25D 21/08; C09D 11/38; C09D 11/106; C09D 139/06; C08K 3/08; C08K 3/22; C25D 5/34

(52) U.S. Cl. CPC C09D 11/00; C25D 5/34; C25D 5/50; C25D 5/02; C25D 3/12; C25D 3/38; C25D 3/22; C25D 3/44; C25D 3/54; C25D 21/08; C09D 11/38; C09D 11/106; C09D 139/06; C08K 3/08; C08K 3/22; C08K 2003/085; C08K 2003/2241

(57) ABSTRACT

A composition for forming a seed layer, the composition comprising: (a.) a first metal fine particle; and (b.) a metallic component selected from a metal oxide fine particle, an organic metal complex, a second metal fine particle, and combinations thereof, wherein the second metal fine particle has a greater affinity for oxygen than the first fine particle. A seed layer as defined, and a coating including a seed layer and the use of this coating. Further, the invention relates to a method of forming a seed layer comprising applying a composition comprising a first metal fine particle, and a metallic component selected from a metal oxide fine particle, an organic metal complex, a second fine metal particle, and combinations thereof, wherein the second metal fine particle has a greater affinity for oxygen than the first metal fine particle to a surface of a substrate, and setting the composition.

### FIELD

The invention relates to compositions and methods for forming seed layers, to the seed layers themselves, to coatings including the seed layers and to articles so coated. In particular, the invention relates to compositions comprising metal fine particles and a stabilising agent.

### BACKGROUND

Coating processes are well known and have been used for millennia. One such coating process is metal plating, introduced hundreds of years ago and still in common use today. Modern deposition techniques include vapour deposition, sputtering, electroplating and electroless processes, and these have wide utility in both industry and art.

Electroless and electroplating processes are well known for depositing metal coatings, such as copper, nickel, or zinc, among others, onto smooth non-metallic surfaces (metalizing).

It is possible to use, for instance an electroless copper or nickel bath for electroless copper-plating or nickel plating, the electroless bath typically comprising a copper salt or nickel salt, respectively, for example copper/nickel sulphate or copper/nickel hypophosphite, and also a reducing agent, such as formaldehyde or a hypophosphite salt, for example an alkali metal or ammonium salt, or hypophosphorous acid, and additionally one or more complexing agents such as tartaric acid, and also a pH adjuster such as sodium hydroxide.

Electroless plating is the controlled autocatalytic deposition of a continuous film of metal without the assistance of an external supply of electrons. Non-metallic surfaces may be pretreated to make them receptive or catalytic for deposition. All or selected portions of a surface may suitably be pretreated. The main components of electroless copper baths are the copper salt, a complexing agent, a reducing agent, and, as optional ingredients, an alkaline, and additives, as for example stabilizers. Complexing agents are used to chelate the copper being deposited and prevent the copper from being precipitated from solution (i.e. as the hydroxide and the like). Chelating copper renders the copper available to the reducing agent which converts the copper ions to metallic form.

Similar compositions can be used for electroless nickel baths which contain a nickel salt, a complexing agent and a reducing agent and the optional ingredients described above.

U.S. Pat. No. 4,617,205 discloses a composition for electroless deposition of copper, comprising copper ions, glyoxylate as reducing agent, and a complexing agent, for example EDTA, which is capable of forming a complex with copper that is stronger than a copper oxalate complex.

U.S. Pat. No. 7,220,296 teaches an electroless plating bath comprising a water soluble copper compound, glyoxylic acid and a complexing agent which may be EDTA.

US 20020064592 discloses an electroless bath comprising a source of copper ions, glyoxylic acid or formaldehyde as reducing agent, and EDTA, tartrate or alkanol amine as complexing agent.

The electroless process uses a chemical reducing agent in solution without the application of external electrical power and is used extensively with copper for metalizing printed circuit boards (PCBs). Whereas electroplating involves the application of a voltage to the substrate and the metal plates onto the substrate directly where the voltage is applied.

As the dimensions of circuit lines continue to get smaller, electroless and electroplating deposition will only become more attractive for PCB and other products where conductive structures are required.

One problem faced when using electroless or electroplating processes to metalize smooth, nonmetallic surfaces is one of adhesion of the metal plate to the surface. Many methods have been developed to address this issue, including for electroless copper plating, the use of catalysts, in particular palladium catalysts deposited on the surface to be plated in order to initiate plating. However, palladium is very expensive, and although it activates the process, additional preliminary sensitization processes are required to ensure the catalyst can be bonded to the substrate. This often requires either mechanical or chemical roughening of the surface to promote good adhesion. For many applications (including PCBs) the roughening of a glass or ceramic substrate is undesirable as it may require the use of hazardous chemicals such as hydrofluoric acid or affect the end performance of the product by modifying the surface properties of the substrate such as dielectric or optical performance.

Electroplating is often used in conjunction with electroless deposition, in particular for copper deposition. This process is generally used where thicker layers of metal are needed.

Further attempts to improve the palladium catalyst electroless and electroplating systems include using an alcohol treatment with heat treatment, but still using palladium. For instance, direct copper deposition on glass without etching has been accomplished by introducing an alcohol treatment after the conventional sensitization and activation steps. When followed by electroless copper deposition, adhesion strength was improved by heat treatment under an inert atmosphere (“Direct Electroless Copper Plating on Glass”, Journal of The Surface Finishing Society of Japan Vol. 58 (2007), No. 10 p. 612).

Further, it has been found that the pretreatment of the substrate with silane can enhance the adhesion of the metal coating, when used in conjunction with a catalyst. For instance, a solid copper film has been deposited onto a glass substrate using electroless copper plating by using y-mercaptopropyltrimethoxysilane (MPTS) to form self-assembled molecular layers on the glass substrate. The MPTS layers were then activated using colloidal silver resulting in a quicker deposition of copper metal and a stronger adherence of the copper film onto the MPTS-modified glass surface (“Electroless plating of copper through successive pretreatment with silane and colloidal silver”, Zheng-Chun Liu, Colloids and Surfaces A: Physiochemical and Engineering Aspects, Vol. 257-258, 5 May 2005, pp. 283-286).

Metals have also been patterned onto substrates using silanes with palladium-tin catalysts, for instance, Deleamarche et al. have used electroless methods to deposit copper onto glass as follows: (i) self-assembling a thin layer of amino-derivatized silanes to the glass, (ii) binding palladium-tin catalytic particles to the silanes, (iii) electroless deposition of copper on the catalytic surface, (iv) microcontact printing hexadecanethiol on the copper film, and (v) selectively etching the printed copper using hexadecanethiol as a resist. This method is particularly attractive for the fabrication of metallic gates for thin-film transistor liquid-crystal displays (“Electroless deposition of Cu on glass and patterning with microcontact printing”, E. Deleamarche, et al., Langmuir, 2003, 19(17) pp. 6567-6569).

Zinc oxide has been shown to provide improved adhesion when used as a seed layer between a glass substrate and electroless copper. The layer was deposited via a pyrolysis process before a palladium based catalyst was deposited onto the zinc oxide layer (Electroless Copper Plating Using ZnO Thin Film Coated on a Glass Substrate, J. Electrochem. Soc., Volume 141, Issue 5, pp. L56-L58 (1994)).

However, silane materials have been found by the applicant to still provide unsatisfactory results. Furthermore, due to the propensity of electroless metals to attack and dissolve organic species, other organic adhesion promoters have failed to provide adequate adhesion and strength. It would therefore be desirable to provide a composition that could be used in promoting adhesion of plated metals onto substrates, providing robust coatings in a cost effective manner.

The invention is intended to overcome or ameliorate at least some aspects of this problem.

### SUMMARY

Accordingly, in a first aspect of the invention there is provided a composition for forming a seed layer, the composition comprising:
a. a first metal fine particle; and
b. a metallic component selected from a metal oxide fine particle, an organic metal complex, a second metal fine particle, and combinations thereof.

It will generally be the case that the second metal fine particle has a greater affinity for oxygen than the first fine particle.

The composition above can be used to form seed layers, in particular seed layers for electroplating or electroless deposition processes in a simple way. There is no need to use toxic or hazardous chemicals, and whilst catalysts (such as palladium catalysts) may be used, they are not required. Even when a catalyst is used, the catalytic loading can be dramatically reduced, thereby reducing the overall cost of the process, loadings as low as 1-10 ppm may be used, compared to typical commercial loadings in the range 10-500 ppm. As such, the composition of the invention need not include or be used with a catalyst, in particular a palladium catalyst.

In addition, the seed layers formed can then be used with standard commercially available coating techniques, which require effectively no adaptation for application to the seed layer as opposed to the substrate directly. In addition, the coatings produced have a surface layer (such as a plated metal) which adheres well to the substrate, providing a robust coating resistant to scratching, which is also smooth and continuous across the seed layer. The provision of a smooth metallic coating is of great importance for optical applications, using the compositions described in this application to form seed layers has been shown to provide surface roughnesses of the coating which are extremely low, in the region of Ra=20-30 nm.

### DETAILED DESCRIPTION

As used herein reference to “a first metal fine particle”, to “a second metal fine particle”, and to “a metal oxide fine particle” is intended to include reference to a plurality of such particles.

The inclusion of the first metal fine particles in the composition helps to activate seed layers formed from the composition during application of the surface layer, particularly when application is using electroless or electroplating processes.

The first metal fine particles may be formed from any metal but often they will be selected from copper fine particles, zinc fine particles, nickel fine particles, chromium fine particles, gold fine particles, silver fine particles, tin fine particles, cobalt fine particles, platinum fine particles, palladium fine particles, and combinations thereof. It may be the case that opposed to a mixture of fine particles, each particle being formed of a specific metal, that the fine particles may be alloys of more than one metal, or may include additional components other than the metal.

Often the first metal fine particles are selected from copper fine particles, zinc fine particles, nickel fine particles, and combinations thereof, often they will comprise copper fine particles whether alone or in combination with another metal. Where copper is present in combination with another component, it will often be present in greater than 50% by mass of the first metal fine particles, often in the range 50-100% by mass, or 70-99% by mass, or 90-95% by mass.

In some examples, the first metal fine particles will be selected such that at least a component of these is the same metal as the metal which will form the surface layer, often only one type of first metal fine particle will be used, and this will be the same metal as the metal which will form the surface layer. This can be advantageous to facilitate improved adhesion between the seed layer and the surface layer of the final coating, due to interaction between like metals.

The metallic component may be a metal oxide fine particle, an organic metal complex, a second metal fine particle or combinations thereof. Often the metallic component will be an organic metal complex alone or in combination with a metal oxide fine particle. Alternatively, the metal oxide fine particle may be used alone. Where a second metal fine particle is present, the metal oxide fine particle and/or the organic metal oxide may be absent, although any combination of these three components may be used.

Metal oxide fine particles are generally present to improve the robustness of the seed layer, and hence the resulting coating. They will often be chosen for their low reactivity, ready availability and low cost and may be selected from any metal, including d-block metal oxides, f-block metal oxides (in particular the lanthanide oxides), p-block metal oxides and combinations thereof. S-block and actinide metal oxides will seldom be used. The metal oxide fine particles can usefully be photocatalytic as when used with light based setting methods, such as laser curing, removal of solvents and other organic materials such as coating agents is promoted as the photocatalytic fine particles can break these down.

In particular, metal oxide fine particles may be selected from oxides of titanium, zinc, tungsten, zirconium, vanadium, chromium, molybdenum, manganese, iron, ruthenium, cobalt, rhodium, nickel, copper, silver, cadmium, cerium, silicon, aluminium, tin, and combinations thereof. In some examples, the metal oxide fine particles are selected from oxides of titanium, zinc, tungsten, zirconium, nickel, copper, silver, cerium, silicon, aluminium and combinations thereof. It has been found to be advantageous for the metal oxide fine particles to comprise titanium as oxides of titanium, (in particular titania, although titanium monoxide or titanium trioxide can also be used), have been found to provide a robust seed layer when used in combination with the metal fine particles. Titania, being photocatalytic and hydrophilic, also has the advantages that it can improve coverage of the substrate and that when the composition is set using light based methods, volatile components can be removed from the seed layer more easily. As can be seen, as used herein, the term “metal” is intended to include semi-metals such as silicon.

Where present, the second metal fine particle will typically be selected to have a greater affinity for oxygen than the first metal fine particle. The presence of the second metal fine particle yet further improves the adhesion of the composition to the substrate and the surface layer.

The oxygen affinity of a metal is easy to measure, and these values are readily available in textbooks. As used herein, the term is intended to be relative, such that under any given set of conditions, the second metal fine particle will have a greater oxygen affinity than the first metal fine particle. These conditions include parameters such as temperature, pressure of oxygen, and particle size.

Metals that may be used include chromium, vanadium, molybdenum, nickel, and combinations thereof. The second metal fine particle is present to improve adhesion to a substrate, the improved adhesion being believed to result from the increase in oxygen affinity of the metal. It may be the case that opposed to a mixture of fine particles, each particle being formed of a specific metal, that the fine particles may be alloys of more than one metal, or may include additional components other than the metal.

The particle size diameter of the first and second metal and of the metal oxide fine particles can affect the properties of the seed layer. Reducing the size of the fine particles increases the reactivity of the particles and improves packing of the seed layer, providing a layer of more uniform thickness and consistency. As such it will often be the case that the fine particles will be microparticles or nanoparticles. The use of nanoparticles in particular provides a surface which is smooth, and which provides a good surface for plating. As such, the first metal, second metal and/or the metal oxide microparticles may have a mean particle size diameter (along longest axis) in the range 0.1-100 μm, often 1-50 μm. Metal and/or metal oxide nanoparticles may have a mean particle size diameter (along longest axis) in the range 1-100 nm (i.e. the nanoparticles should at least be of nanoparticulate size), often in the range 5-50 nm or in the range 10-20 nm. Often the first metal, second metal and the metal oxide fine particles will be selected to be of similar size to one another to promote good packing within the seed layer.

It will be understood that reference to compositions comprising a first metal fine particle, a metal oxide fine particle and a second metal fine particle includes reference to compositions where each type of particle is discrete and of different composition, and compositions where the fine particles are composites. For instance, the composition may comprise discrete particles selected from a first metal fine particle, a metal oxide fine particle, a second metal fine particle and an organic metal complex. As described above within the discrete fine particles, the first metal fine particle may be a mixture of metals, providing that the metal alloy is of lower oxygen affinity than the second metal fine particle where this is present (i.e., the combined oxygen affinity of the metals in the alloy is lower than the oxygen affinity of the second metal fine particle). Often, the first discrete metal fine particle will comprise substantially one metal, by which is meant greater than 95%, often greater than 98% of the first metal fine particle will be a single metal. Similarly, the second metal fine particle may be a mixture of metals, providing that the metal alloy is of greater oxygen affinity than the first fine particle (i.e., the combined oxygen affinity of the metals in the alloy is greater than the oxygen affinity of the first metal fine particle). Often the second discrete metal fine particle will comprise substantially one metal, by which is meant greater than 95%, often greater than 98% of the second metal fine particle will be a single metal. The metal oxide fine particle may be a mixture of metal oxides, although often only a single metal oxide will be used. Where the metal oxide fine particle comprises a single metal oxide, the metal oxide will comprise 95%, often greater than 98% of that metal oxide.

Alternatively, one or more of the components of the composition may be present as composite fine particles (or where these are entirely metallic as alloys). By composite fine particle we mean that some or all of the individual particles contain more than one component of the composition. For instance, there may be composite particles comprising the first and second metal, the first metal and the metal oxide, or the second metal and the metal oxide. The organic metal complex may also be integrated into the composite particles in some examples. Where composite particles are formed, these will often be roughly stoichiometric, by which we mean that where a composite particle of a first metal and a metal oxide is formed, the ratio will be 1:1 metal:metal oxide (for instance, for copper and titanium dioxide, a composite fine particle comprising CuTiO2 could be formed).

In some examples, the first metal fine particles, second metal fine particles and/or the metal oxide fine particles are coated, where the coating may be achieved using known fine particle coating techniques, including those described in the applicant's co-pending applications based upon WO 2010/073021 incorporated herein by reference. Coating can be of use to reduce agglomeration of the metal oxide and first/second metal fine particles during storage of the composition, and to reduce the surface oxidation of the first/second metal fine particles where these are formed from a metal that is prone to oxidation, such as zinc or copper. The prevention of oxidation can be desirable as many coating techniques, including electroless coating processes, require electron transfer, which is inhibited by oxidation of the fine particle surface. Equally, to retain high conductivity during electroplating oxidation of the metal should be minimized. It has been shown that coating metal fine particles can retard oxidation by more than 90% (WO 2010/073021). Alternatively, where coating is not desired, and the metal is readily oxidizable, an acid pre-dip may be used to reduce or remove any oxidation layer. In some examples it can be beneficial to allow an oxide layer to form on the metal fine particle with the specific intention of removing this (for instance with and acid pre-dip) prior to applying a surface layer. This oxide layer provides for stronger bonding of the seed layer to a substrate; but removal of the oxide from the exposed surfaces can improve bonding of the seed layer to the surface layer.

The coating, if present, may be partial or total, although oxidation and agglomeration will be more effectively prevented if coating is total in that it substantially covers the first/second metal fine particle or metal oxide fine particle core. Often the coating is selected from a material that forms reversible bonds with the fine particle core, so that the coating may be removed easily once its function has been served. Often the coating will be organic, as organic coatings have been found to work in this way. Often the coating will be a polar organic molecule as these form effective monolayers, the coating being selected in many cases from: surfactants, carboxylic acids, sulfates, alcohols, nitrates, phosphates, amines, amides, thiols, polymers, and combinations thereof In many cases the coating will be selected from a carboxylic acid, thiol, polyvinylpyrrolidone and combinations thereof

In some instances, an organic metal chelating complex will be present, this may be in addition to the second metal fine particles, the metal oxide fine particles or instead of one or both of these. For the avoidance of doubt, as used herein the term “organic metal complex” is intended to mean complexes formed between one or more metals (typically one) and organic ligands. It can be useful to include an organic metal complex in order to maximize packing density, thereby providing a smoother seed layer surface and ultimately a smoother coating. A smoother seed layer surface can be formed using organic metal complexes as the organic metal complex can readily percolate between the gaps left by the first and optionally second metal fine particles, filling these and densifying the structure.

Often the organic metal complex comprises chelating ligands, chelating complexes stabilise the metal preventing unwanted oxidation. Alternatively, the organic metal complex may comprise monodentate organic ligands, such as metal alkoxides. One alkoxide of particular interest is isopropoxide, as this material readily breaks down to form oxide films at temperatures of approximately 100° C. In particular, where titanium isopropoxide is used, a titania film can be produced at these low temperatures.

It can be advantageous to disperse the organic metal complex in a mixture of lactate and acetylacetone or in alcoholic solution. This produces a more stable metal complex. These chelating agents increase the stability of the metal complex such that the temperature of decomposition of the complex is increased above 140° C. This increased stability ensures that when the material is thermally cured (for instance using a laser), the formation of the oxide, and removal of any organic coating occurs simultaneously. This leads to a greater uniformity of composition within the seed layer, and also to a denser seed layer.

The composition will typically, but not always, additionally comprise a solvent.

The solvent will often be selected on the basis of the substrate to which the composition will be applied. For instance, the solvent may be selected to improve the wettability of the substrate, and hence adhesion of the seed layer to this. The solvents may be selected from, for instance, water, water miscible solvents and organic solvents. For instance, the solvent may be water, an alcohol (in particular ethanol, butanol, isopropyl alcohol, ethylene glycol), dichloromethane, cyclohexane, dimethylformamide, acetone, toluene, ethyl acetate, hexane, ether or combinations thereof. Often the solvent will be a hydrophilic solvent to improve dispersion of the metal oxide, first and second metal fine particles, and wettability of the substrate, often water or ethanol will be selected as these are inexpensive and readily available, with ethanol often being used to reduce the surface tension of the composition and hence increase its wettability.

In a second aspect of the invention there is provided a seed layer comprising a composition according to the first aspect of the invention. The seed layer is found on a substrate to be coated and will generally be of defined, intentionally substantially uniform, depth. The provision of a seed layer of uniform depth helps to ensure a smooth surface to the seed layer, and hence a higher quality coating once the surface layer has been applied, as this can be smooth and even. The depth of the seed layer will often be in the range 0.1-3 μm, generally 250-500 nm for inkjet printing or spin coating applications and 1-3 μm for gravure or flexographic printing. Thinner seed layers may be used, but these will typically lack the robustness of seed layers within this range, whereas thicker seed layers carry an increased risk of cracking of the layer during solvent evaporation.

The seed layers can be used for electroplating or electroless plating processes. The surface thus rendered conductive can subsequently be electrolytically further metallized.

For electrolytic metallization, it is possible to use any metal deposition baths, for example for nickel, copper, silver, gold, tin, zinc, iron, lead or alloys thereof can all be deposited using this method. Such deposition baths are familiar to those skilled in the art. A Watts nickel bath is typically used as a bright nickel bath, this comprising nickel sulphate, nickel chloride and boric acid, and also saccharine as an additive. An example of a composition used as a bright copper bath is one comprising copper sulphate, sulfuric acid, sodium chloride and organic sulphur compounds in which the sulphur is in a low oxidation state, for example organic sulphides or disulphides, as additives.

Optionally, the seed layer can be activated prior to the final metallisation step. For this, the surface including the seed layer is treated with a solution of a metal colloid or of a compound of a metal. The metal of the metal colloid or of the metal compound is generally selected from groups 8 to 10 or group 11. The metal of groups 8-10 is often selected from palladium, platinum, iridium, rhodium and a mixture of two or more of these metals. The metal of group 11 is often selected from gold, silver and a mixture of these metals. Often the metal in the metal colloid is palladium.

The metal colloid may be stabilized with the protective colloid. The protective colloid can be selected from metallic protective colloids, organic protective colloids and other protective colloids. The metallic protective colloid, will often comprise tin ions. The organic protective colloid is often selected polyvinyl alcohol, polyvinylpyrrolidone and gelatine, in many cases polyvinyl alcohol.

Often, the solution of the metal is an activator solution with a palladium/tin colloid. This colloid solution is obtained from a palladium salt, a tin(II) salt and an inorganic acid. A often the palladium salt is palladium chloride. Often the tin(II) salt is tin(II) chloride. The inorganic acid may be hydrochloric acid or sulfuric acid, preferably hydrochloric acid. The colloid solution forms through reduction of the palladium chloride to palladium with the aid of the tin(II) chloride. The conversion of the palladium chloride to the colloid is complete; therefore, the colloid solution no longer contains any palladium chloride. The concentration of palladium is often 5 mg/l-100 mg/1, more often 20 mg/l-50 mg/l and sometimes 30 mg/l-45 mg/l, based on the concentration of Pd²⁺. The concentration of tin(II) chloride is often 0.5 g/l-10 g/l, preferably 1 g/l-5 g/l and more often 2 g/l-4 g/l, based on Sn²⁺. The concentration of hydrochloric acid is often 100 ml/l-300 ml/l (37% by weight of HCl). In addition, a palladium/tin colloid solution can additionally comprise tin(IV) ions which form through oxidation of the tin(II) ions. The temperature of the colloid solution during process step b) may be in the range 20° C.-50° C. and often will be in the range 35° C.-45° C. The treatment time with the activator solution is often 0.5 min-10 min, in some cases 2 min-5 min and very often 3 min-5 min. It is, however, an advantage of the present invention that such activation of the seed layer prior to the metal deposition is not required for most of the applications, therefore rendering the inventive process more easy than a prior art processes. The seed layer alone generally provides a sufficient adhesion on glass surfaces without use of pretreatment.

The seed layer thickness can vary from 200-1000 nm, preferably from 250 and 500 and even more preferred from 250 to 400 nm. The seed layer line width may be around 15 μm (tested), optionally around 10 μm (shown) or 5 μm (announced).

After deposition of the seed layer wet-chemical pre-treatment/activation by an aqueous acidic solution, preferably H₂SO₄, can be performed. The acid concentration, particularly of H₂SO₄, can vary between 5-40 wt. %, often between 5 and 20 wt. %, and in many cases up to 10 wt. %. Treatment temperature can be room temperature or slightly higher, e.g. between 20° C. and 40 or 50° C. The process time is dependent on the substrate and generally ranges between 20 s-2 to 5 min.

The thickness of the deposited metal layer, particularly of the copper and nickel layer, generally ranges between 0.1 and 20 μm, often between 0.5 and 15 μm and even more often up to 5 or 10 μm.

According to a third aspect of the invention there is provided a coating including a seed layer according to the second aspect of the invention, and a surface layer. The surface layer will generally be metallic, and will often, but not always, be selected from the same metal which forms the first metal fine particles of the composition (although in some instances the same metal as forms the second metal fine particles may be used). The surface layer may be any metal capable of being applied using known coating techniques such as electroplating or electroless deposition methods. For instance, the metal may be selected from copper, zinc, nickel, chromium, gold, silver, tin, cobalt, platinum, palladium, and combinations thereof. In some cases, the metal may be selected from copper, zinc, nickel and combinations thereof. Often, the surface layer comprises copper. The copper may be alone or in combination with other metals. Copper is often selected because of its availability, good working properties and conductivity, all of which make copper coatings suitable for use in a wide variety of applications.

The surface layer may be of depth in the range 0.5-2 μm, often 1-1.5 μm where it is applied through electroless plating, and in the range 10-50 μm where electroplating techniques are used. These depths provide a robust, reliable coating without introducing too great a risk of non-uniformity.

According to a fourth aspect of the invention there is provided an article comprising a coating according to the third aspect of the invention. The article may be any article to which it is desirable to apply a coating, in particular a metallic coating. Often, however, the article will be at least partially composed of a plastics material, glass, or ceramic. Often the article will comprise at least one polymeric, glass, or ceramic surface to which the coating is applied. The plastics material may be selected from polyethylene terephthalate, polyethylene napthalate, polyimide, polycarbonate, acrylonitrile butadiene styrene, and combinations thereof

According to a fifth aspect of the invention, there is provided a method of forming a seed layer comprising:
a. applying a composition comprising a first metal fine particle, and a metallic component selected from a metal oxide fine particle, a second fine metal particle, an organic metal complex, and combinations thereof, wherein the second metal fine particle has a greater affinity for oxygen than the first metal fine particle to a surface of a substrate; and
b. setting the composition.

The process generally involves forming a seed layer between the substrate and a surface layer. This seed layer enables greater adhesion of the surface layer to the substrate. Since the seed layer does not require the presence of a catalyst (or a lower catalytic loading is used) to enable application and adherence of the surface layer, it is also significantly cheaper than the commonly used processes.

The method may comprise the additional step of cleaning the substrate before application of the composition, cleaning ensures good adherence of the composition to the substrate surface and reduces imperfections in the surface, and hence their replication in the seed layer and ultimate coating. Thus the smoothness and robustness of the final coating is improved. Cleaning of the surface may be with solvent systems that remove water, moisture, and surface dirt/contamination, such as dust particles and grease. Additionally or alternatively more sophisticated approaches that use surfactant cleaners to remove surface dirt combined with solutions that functionalise surfaces and modify their surface tension (and hence wetting characteristics) may be used. For instance, potassium hydroxide or sodium hydroxide may be used to hydrolyse the surface and improve adhesion due to coating of the surface with hydroxyl species.

Application of the process to the substrate may be by a wide variety of methods that will be familiar to the person skilled in the art. Application may, for instance, be using any known printing method including gravure, inkjet, litho, offset gravure, flexo, offset flexo, aerosol, or pad printing, used alone or in combination. The use of printing provides for a simplified method of forming the seed layer as it provides for the direct application of the composition to the substrate, where such direct application is desired. Alternatively, the application of a coating may be performed using spray coating techniques, in particular using ultrasonic spray coating devices. Further, spin coating techniques may also be used to apply the coating. As the surface layer will only adhere (or at least only adhere well) to the areas of the substrate covered with the seed layer, the process of the invention can be a purely additive process (as opposed to the traditional subtractive processes where aspects of the surface layer must be removed from the substrate, for instance where fine detail is needed), this is particularly the case where the surface layer is being applied using plating techniques. The use of a seed layer therefore provides for the combination of the advantages of a direct printing process with the high conductivities which can be achieved for metallic surface layers when technologies such as electroless and electroplating are used.

The composition can be altered not just to accommodate adhesion to different substrates, but so that it is appropriate for use with different application techniques. For instance, the rheology of the composition could be altered so that it is suitable for use with different printing techniques, by altering the concentration of the first metal fine particle, second metal fine particle, or metal oxide fine particle, or the nature or concentration of the solvent. For instance, for inkjet printing a metal fine particle concentration of 5-40 wt % may be used (total metal fine particle concentration, i.e., the sum of the first and second metal fine particles), whereas for gravure a metal fine particle concentration of 20-70 wt % could be employed.

An additional drying step may be included in the method, prior to setting of the composition. This drying step can be an important step in ensuring good surface morphology, drying parameters should generally be selected based on the vaporization rate of the various solvents contained in the ink. Any cracking or fracturing in the seed layer will be followed by the surface layer, and so it is desirable to ensure that cracks/fractures are minimized, this can be achieved by the selection of drying parameters appropriate to the seed layer thickness, as would be understood by the person skilled in the art.

Setting of the composition generally involves a sintering process between the first (and optionally the second) metal fine particles and the metal oxide fine particles. During the sintering process the metal fine particles will sinter with the metal oxide fine particles combining to form a densified structure. As these materials bond together a localized galvanic cell is created which also promotes electroless activation. The metal oxide fine particles and metal fine particles also sinter/melt to form a very strong adhesion to the substrate. In addition, the metal oxide fine particles act as a scaffold structure for the seed layer that reinforces good adhesion. Electroless activation can also be increased by increasing the concentration of first and optionally second metal fine particles relative to the metal oxide fine particles or the organic metal complex.

Often the setting of the composition will be using laser curing or laser patterning techniques, such as those described in the applicants' co-pending UK patent application number 1114048.0 which describes the use of a bar diode to sinter a composition.

When using a laser process, a metal oxide film is simultaneously produced as any organic coating on the metal fine particles (for instance from the solvent, other components of the composition or a coating specifically applied to reduce oxidation of the surface of the fine particle) is removed. The selection of a photocatalytic metal oxide fine particle can be of use in the removal of organic matter in general, and in assisting in the breakdown of coatings on the surrounding metal fine particles.

It may be that where fine structure is to be created within the coating, that laser patterning is favored. In such cases, any excess unsintered composition may be removed, for instance by washing from the substrate. A variety of removal techniques may be used, such as the use of amine or hydroxide based developers, as would be known to the person skilled in the art, although often the technique described in the applicants' co-pending UK application 1113919.3 (published as WO 2013/024280 A1) will be adopted. This application describes the creation of very fine resolution structures, such as may be desirable in printed circuit board applications, and their creation using, at least in part, a wash process as described.

The setting of the composition may comprise baking the composition, typically in combination with, and generally after, laser curing or laser patterning. Where laser patterning is used, or another method that produces fine detail and where unwanted composition must be removed from the substrate, the baking will typically occur after the unwanted substrate has been washed off the substrate, or otherwise removed.

In a sixth aspect of the invention, there is provided a method of coating an article comprising:
a. forming a seed layer using a method according to the fifth aspect of the invention;
b. activating the seed layer;
c. applying a surface layer to the seed layer; and
d. setting the surface layer.

It will often be the case that activating the seed layer comprises reducing oxidation on the surface of the seed layer. This may be achieved by acidifying the seed layer, a wide range of acids may be used, selected on the basis of reactivity with the components of the composition and ionising ability. Weak acids will be used such as acetic acid, or citric acid; however more often, dilute solutions of strong acids such as hydrochloric acid, sulfuric acid and nitric acid, may also be used. The acids may be used alone or in combination. Often sulfuric acid will be used due to its low cost and ability to remove any surface oxidation on the metal fine particles.

The applying of the surface layer to the seed layer may be achieved in a number of ways, including vapour deposition, spluttering, electroless, electroplating or combinations thereof. Often, however, electroless or electroplating will be used, whether alone or in combination because of their wide applicability and ease of use. In the case of electroless copper deposition, the choice of nanometal may be such that effective catalytic behavior is promoted, for instance, by providing adsorption sites for the reducing agent (such as formaldehyde) and by allowing electron transfer to enable the metal ions in solution to be reduced to a deposited solid surface layer.

The setting of the surface layer, like the seed layer, will often comprise baking of the article to ensure that the coating is sufficiently hard and robust to last.

In a seventh aspect of the invention there is provided the use of a coating according to a third aspect of the invention in the production of coated glass articles. This use may be for a variety of applications including flat panel display elements, organic LEDs, solar cells, touch screen display elements, electronic device packaging elements, and more generally in the production of printed circuit boards.

Unless otherwise stated each of the integers described in the invention may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

### EXAMPLES

### Example 1

### Coating Preparation

A copper coating was prepared using a seed layer of coated copper nanoparticles and titania nanoparticles using the method provided below.

Electroless copper activation was achieved by deposition of a seed layer on Corning Glass 1737 followed by immersion in an electroless bath for 30 mins. The Corning glass was cleaned using a 5% degreasing agent with ultrasonication, followed by dipping in a 3% sodium hydroxide solution for 30 mins followed by a wash in isopropanol. Between each step the glass was rinsed with deionized water. The seed layer composition was comprised of a 12% solid loaded ink comprising 60% polyvinyl pyrrolidone coated nanocopper and 40% nanotitania. The mixture was dispersed in an 80% ethylene glycol and 20% butanol mixture and spin coated onto the sample. The layer was dried at 60° C. for 20 mins. A 2 mm track was sintered by directing a focused 808 nm laser across the sample. Unsintered regions were removed with a 3% amine based developer solution.

The material was baked at 350° C. in an argon/hydrogen gas mixture for 1 hour. The seed layer was then dipped into a 10% sulphuric acid bath for 1 minute, washed in deionized water and then submerged in an electroless bath for 30 mins. An electroless copper layer of approximately 0.8 μm was deposited. The sample was then baked at 350° C. in nitrogen.

Surface roughnesses of Ra less than 50 nm were observed.

### Example 2

### Coating Preparation

A copper coating was prepared using a seed layer of copper nanoparticles and silica nanoparticles using the method provided below.

Electroless copper activation was achieved by deposition of a seed layer on Corning Glass 1737 followed by immersion in an electroless bath for 30 mins. The Corning glass was cleaned in a 3% sodium hydroxide solution for 30 mins followed by a wash in isopropanol. The seed layer composition was comprised of a 20% solid loaded ink comprising 60% polyvinyl pyrrolidone coated nanocopper and 40% nanosilica. The mixture was dispersed in an 80% ethylene glycol and 20% butanol mixture and spin coated onto the sample. The layer was dried at 60° C. for 20 mins. A 2 mm track was sintered by directing a focused 808 nm laser across the sample. Unsintered regions were removed with a 3% proprietary amine based developer solution.

The material was baked at 300° C. in an argon/hydrogen gas mixture for 1 hour. The seed layer was then dipped into a 10% sulphuric acid bath for 30 seconds, washed in deionized water and then submerged in a electroless bath for 30 mins. An electroless copper layer of approximately 1.5 μm was deposited. The sample was then dried at 80° C. in air.

Surface roughnesses of Ra less than 50 nm were observed.

### Example 3

### Coating Preparation

An alcohol dispersion (80% ethylene glycol, 20% butanol) containing 67% nanonickel and 33% nanocopper at a total 12% metal loading (both nanoparticles containing a polyvinyl pyrrolidone coating) is inkjet printed onto a polyimide surface using a Dimatix SE-128 print-head. The nanomaterials are sintered using a 1064 nm laser to create a seed layer.

A copper layer is grown on the seed layer to a thickness of ˜1 um using a commercially available electroless copper chemistry.

The metallized layer demonstrates good resistance to adhesion testing.

### Example 4

### Coating Preparation

A formulation containing nanocopper with a polyvinyl pyrrolidone coating at 12% weight loading dispersed in a solvent mixture comprising 10% acetylacetone, 10% Ti isopropoxide, 64% ethylene glycol and 16% butanol. The dispersion was spin coated on glass substrate which had been precleaned with a 5% degreaser solution followed by 3% NaOH rinse.

The seed layer was sintered using an 808 nm laser and good adhesion was observed of the seed layer to the glass substrate.

### Example 5

### Coating Preparation

An 80% nanocopper (PVP coated)/20% nanotitania dispersion (80% ethylene glycol/20% butanol) is deposited onto a glass substrate and sintered with a 1064 nm laser.

The structure is processed on a horizontal conveyor system through a sulphuric acid (10%) solution followed by an electroplating bath that uses a high current density commercially available electroplating solution. A thickness of 20 um is plated, with the final layer demonstrating good adhesive properties.

### Example 6

### Coating Preparation

Corning 1737, alkali-free borosilicate glass, thickness: 0.7 mm was metalised as described below.

The glass substrate was cleaned by immersion of the glass in a 5 wt % degreaser liquid for 1 hour at 30° C. with ultrasonic support. The glass was then rinsed (twice) with separate DI immersion rinses with a dip time of 2 min in each bath with ultrasonics, prior to immersion in sodium hydroxide (3 wt %, 1 hour, room temperature), again with sonication. The sodium hydroxide was removed with rinsing (twice) with DI immersion rinses with a dip time of 2 min in each bath with ultrasonics, followed by drying at room temperature overnight.

Spin-coating was with a Cu/TiO₂-nano-particle based ink (12% solid loaded ink with 60% polyvinyl pyrrolidone coated nano-Cu and 40% nanotitania). This was dispersed in an 80% ethylene glycol and 20% butanol mixture. The spin-coated substrate was then dried in a vacuum oven for 20 minutes at 60° C.

An 808 nm laser (power 13 A, approximately 5 W) was used to cure the ink, which was then washed with a 5 wt % amine based developer solution with sonication. This resulted in a 2 mm line width. The coated substrate was dried for 1 hour at 350° C. in a hydrogen/argon gas mixture.

Wet-chemical pretreatment was then implemented by application of a 10% H₂SO₄ solution, for one minute at room temperature prior to rinsing with DI water. The substrate was then ready for the electroless copper deposition.

Deposition was effected using a commercially available electroless copper plating bath comprising a copper ion source, a complexing agent and formaldehyde as reducing agent. Plating time was 30 min at a temperature of 32° C. resulting in a 1.2 μm copper layer. The coated substrate was rinsed in DI water and dried using compressed air prior to annealing for 1 hour at 350° C. in N₂-atmosphere.

### Example 7

### Coating Preparation

The method of Example 6 was repeated with the following changes. Laser curing was of power 20 A approximately 8 W. The wet chemical pre-treatment step was carried out for only 30 seconds, rather than one minute, and the plating time of 20 minutes at a temperature of 50° C., resulting in a copper layer of 1.8 μm. The copper deposit again showed good adherence to the substrate.

### Example 8

### Coating Preparation

Corning Eagle XG, alkali-free borosilicate glass, thickness 0.7 mm was metallized as described below.

The glass substrate was cleaned by immersing in a basic solution comprising a 1:1:5 ratio mixture of a 28-30% ammonium hydroxide solution, a 30 wt % hydrogen peroxide solution and water for 30 minutes at 25° C. The substrate was then rinsed with de-ionized water prior to immersion in a 1:1:5 ratio acidic solution consisting of 36.5-28% hydrochloric acid solution, 30% hydrogen peroxide solution, and water for 30 minutes at 25° C. The acidic solution was then rinsed off prior to dipping in acetone to remove excess water and drying with compressed air.

A Cu/TiO₂ nanoparticle based ink (Cu 7.2 wt % +TiO₂ 4.8 wt % dispersed in 60% ethyleneglycol/20 wt 1-methoxy-2-propanol/20 wt % butanol) was inkjet printed onto the substrate to provide a line width of approximately 500 μm. The printed system was then dried in a vacuum oven for 20 minutes at 60° C.

An 808 nm laser (power 36 A, approximately 17 W) was used to cure the ink which was then annealed for 1 hour at 250° C. in a hydrogen/argon gas mixture.

Wet chemical pre-treatment was then implemented by application of a 10% H₂SO₄ solution for 2 minutes at room temperature prior to rinsing with de-ionized water. The substrate was then ready for the electroless copper deposition.

Deposition was effected using a commercially available electroless copper-plating bath comprising a copper ion source, a complexing agent and formaldehyde as a reducing agent. Plating time was 30 minutes at a temperature of 38° C. resulting in a 2.7 μm copper layer. The coated substrate was rinsed in de-ionized water and dried using compressed air prior to annealing to 1 hour at 350° C. in a N₂-atmosphere. Again the copper deposit showed a high adherence to the substrate.

### Example 9

### Coating Preparation

Corning Eagle XG alkali-free borosilicate glass thickness 0.7 mm was metallized as described below.

The glass substrate was cleaned by immersing in a basic solution comprising a 1:1:5 ratio mixture of a 28-30% ammonium hydroxide solution, a 30 wt % hydrogen peroxide solution and water for 30 minutes at 25° C. The substrate was then rinsed with de-ionized water prior to immersion in a 1:1:5 ratio acidic solution consisting of 36.5-28% hydrochloric acid solution, 30% hydrogen peroxide solution, and water for 30 minutes at 25° C. The acidic solution was then rinsed off prior to dipping in acetone to remove excess water and drying with compressed air.

Spin-coating with a Cu/TiO₂-nano-particle based ink (Cu 9 wt % and TiO₂ 6 Wt %). This was dispersed in 60% ethyleneglycol/20wt % 1-methoxy-2-propanol/20wt % butanol mixture. The spin-coated substrate was then dried in a vacuum oven for 20 minutes at 60° C.

A 1064 nm laser (power 2.3 A, approximately 80 J/cm²) was used to cure the ink, which was then washed off with a 1 wt % NaOH de-ionized water solution. This resulted in a 125 μm line width. The coated substrate was dried for 1 hour at 350° C. in a hydrogen/argon gas mixture.

Wet chemical pre-treatment was then implemented by application of a 10% H₂SO₄ solution for 2 minutes at room temperature prior to rinsing with de-ionized water. The substrate was then ready for the electroless copper deposition.

Deposition was effected using a commercially available electroless copper-plating bath comprising a copper ion source, a complexing agent, and formaldehyde as a reducing agent. The solution was agitated with air and the sample was moved within the bath. Plating time was 60 minutes at 32° C. resulting in a 3-6 μm copper layer. The coated substrate was then rinsed in de-ionized water and dried using compressed air prior to annealing for 1 hour at 350° C. in a N₂-atmosphere.

Again, the copper deposit showed a high adherence to the substrate.

### Example 10

### Coating Preparation

The method of Example 9 was repeated with the following changes.

The laser was 1.5 A which is approximately 95 J/cm². This produced a line width of approximately 70 μm. Wet chemical pre-treatment was for 1 minute rather than 2 minutes and the plating temperature was 35° C. These changes resulted in a copper deposit with excellent adherence and of 3.5 μm thickness.

### Example 11

### Coating Preparation

The method of Example 9 was repeated, subject to the following changes.

Spin-coating was used with a 6:4 Cu : TiO₂ ink dispersed at 15 wt % in a 71% butanol, 29% ethyl acetate solution. The laser power applied was 0.58 A (approximately 20 J/cm²) this resulted in a line width of less than 25 μm. Wet chemical pre-treatment with the H₂SO₄ solution was for 1 minute at room temperature and plating time reduced to 15 minutes but at a temperature of 35° C. This resulted in a 1.1 μm copper layer which showed good adherence to the substrate. It should be appreciated that the compositions, layers, coatings, methods and uses of the invention are capable of being incorporated in the form of a variety of embodiments, only a few of which have been illustrated and described above.

1. A composition for forming a seed layer, the composition comprising:
a. a first metal fine particle; and
b. a metallic component selected from a metal oxide fine particle, an organic metal complex, a second metal fine particle, and combinations thereof,
wherein the second metal fine particle has a greater affinity for oxygen than the first fine particle.

2. A composition according to claim 1, wherein the composition comprises a first metal fine particle, a metal oxide fine particle, and/or an organic metal complex.

3. A composition according to claim 1, wherein the composition comprises a first metal fine particle and a second metal fine particle.

4. A composition according to claim 1 wherein the fine particles are nanoparticles.

5. A composition according to claim 1, wherein the first metal fine particle is selected from copper fine particles, zinc fine particles, nickel fine particles, and combinations thereof.

6. A composition according to claim 5, wherein the first metal fine particle comprises copper fine particles.

7. A composition according to claim 1, wherein the metal oxide fine particles are selected from oxides of titanium, zinc, tungsten, zirconium, nickel, copper, silver, cerium, silicon, aluminium, and combinations thereof.

8. A composition according to claim 7, wherein the metal oxide fine particles comprise titanium.

9. A composition according to any preceding claim claim 1, wherein the second metal fine particle is selected from chromium, vanadium, molybdenum, nickel, and combinations thereof.

10. A composition according to claim 9, wherein the second metal fine particle comprises nickel.

11. A composition according to claim 1, wherein the first metal fine particles, the second metal fine particles, and/or the metal oxide fine particles have a mean particle size diameter in the range 5-50 nm.

12. A composition according to claim 1, wherein the metal fine particles and/or the metal oxide fine particles are coated.

13. A composition according to claim 1, wherein the metal fine particles and/or the metal oxide fine particles are composite particles.

14. A composition according to claim 1, wherein the organic metal complex comprises chelating ligands.

15. A composition according to claim 14, wherein the organic metal complex comprises titanium isopropoxide.

16. A composition according to claim 1, wherein the organic metal complex is dispersed in a mixture of lactate and acetylacetone or in alcoholic solution.

17. A seed layer comprising a composition according to claim 1.

18. A seed layer according to claim 17, of depth in the range 1-3 μm.

19. A coating including a seed layer according to claim 17 and a surface layer.

20. A coating according to claim 19, wherein the surface layer comprises a metal selected from copper, zinc, nickel, and combinations thereof.

21. A coating according to claim 20, wherein the surface layer comprises copper.

22. A coating according to claim 19, wherein the surface layer is of depth in the range 0.5-2 μm.

23. An article comprising a coating according to claim 19.

24. An article according to claim 23 comprising at least one polymeric or glass surface to which the coating is applied.

25. A method of forming a seed layer comprising:
a. applying a composition comprising a first metal fine particle, and a metallic component selected from a metal oxide fine particle, an organic metal complex, a second fine metal particle, and combinations thereof, wherein the second metal fine particle has a greater affinity for oxygen than the first metal fine particle to a surface of a substrate; and
b. setting the composition.

26. A method according to claim 25, comprising the additional step of cleaning the substrate before application of the composition.

27. A method according to claim 26, wherein application of the composition comprises printing the composition onto the substrate.

28. A method according to claim 25, comprising the additional step of drying the composition prior to setting.

29. A method according to claim 25, wherein setting the composition comprises laser curing or laser patterning.

30. A method according to claim 29, comprising the additional step of removing unsintered composition where setting of the composition comprises laser patterning.

31. A method according to claim 29, wherein setting the composition comprises baking the composition after laser curing and/or after laser patterning and subsequent removal of unsintered composition.

32. A method of coating an article comprising:
a) forming a seed layer using a method according to claim 25;
b) activating the seed layer;
c) applying a surface layer to the seed layer; and
d) setting the surface layer.

33. A method according to claim 32, wherein activating the seed layer comprises acidifying the seed layer.

34. A method according to claim 32, wherein applying a surface layer to the seed layer comprises electroless plating, electroplating, or a combination thereof.

35. A method according to claim 34, wherein electroless plating is performed directly on the seed layer formed in step a).

36. A method according to claim 34, wherein electroless plating is in a plating bath suitable for the deposition of a copper or nickel layer.

37. A method according to claim 36, wherein the thickness of the copper or nickel layer is in the range 0.1 to 20 μm.

38. A method according to claim 32, wherein setting of the surface layer comprises baking the coated article.

39. A method of production of coated glass articles comprising applying the coating of claim 19 to an article.

40. A method according to claim 39 wherein the article is a flat panel display element, a touch panel display element, an OLED, or a printed circuit board.

41. (canceled)
